(19) United States
(12) Patent Application Publication
(10) Pub. No.: US 2007/0176401 A1
(43) Pub. Date: Aug. 2, 2007

(54) Shield

(76) Inventors: Paul Kenneth Adshead, Ross On Wye (GB); Simon George Melhuish, Nr Ledbury (GB)

Correspondence Address: KING & SCHICKLI, PLLC, 247 NORTH BROADWAY, LEXINGTON, KY, 40507, US

(21) Appl. No.: 10/569,342

(22) PCT Filed: Aug. 21, 2003
(86) PCT No.: PCT/GB03/03672

§ 371 Date: Sep. 22, 2006

(51) Int. Cl. B60R 21/18

(52) U.S. Cl. 280/733

(57) ABSTRACT

A shield includes a sheet (1) of material and a plurality of spaced apart webbing portion (2) attached to the sheet. The webbing portions substantially extend from one end edge of the sheet to an opposite end edge. The shield also includes attaching devices (5, 7) located at or near to both ends of the webbing portions for attaching the shield to a structural member. A fastener device (18) connects a said webbing portion to one end of a strap (16), another end of the strap in use being connected to a webbing portion of another shield or to the structural member.

### FIELD OF THE INVENTION

The present invention relates to shields.

### BACKGROUND TO THE INVENTION

Shields have numerous uses, such as reducing heat convection heat loses; weather protection; wind-shielding; safety devices, or acting as a visual barrier or a baffle to control or direct air movements. Such shields are often used in inhospitable locations (e.g. oil rigs) and so need to be tough and durable, but should also allow a degree of flexibility.

### SUMMARY OF THE INVENTION

Generally, the present invention provides a shield including:

a sheet of material, and

a plurality of webbing portions attached to the sheet,

wherein all or some of the webbing portions substantially extend from one end edge of the sheet to the opposite end edge, and all or some of the webbing portions include a device for attaching the shield to a structural member.

The shield can include a strap for connecting a said webbing portion to another webbing portion. The other webbing portion may be attached to the same shield, or it may be attached to another shield. Thus, the strap can be used to connect two shields together to form a substantially continuous shield.

According to one aspect of the present invention there is provided a shield including:

a sheet of material;

a plurality of spaced apart webbing portions attached to the sheet, the webbing portions substantially extending from one end edge of the sheet to an opposite end edge;

attaching devices located at or near to both ends of the webbing portions for attaching the shield to a structural member, and

a fastener device connecting a said webbing portion to a strap, the strap in use also being connected to a webbing portion of another shield or to the structural member.

A device, such as a ratchet tensioning device, for tensioning the strap may also be provided.

The fastener device can include a pair of plates, in use, one said plate being located on one side of the shield and the other plate being located on the opposite side of the shield. One of the plates can include one or more stud such that, in use, the or each stud presses into the strap and/or the webbing portion of the shield, thereby substantially fixing the strap and/or the webbing portion between the plates. The other plate can include one or more aperture corresponding to the one or more stud. The fastener device may further include a plurality of fixing devices for fixing the two plates together with the strap and the webbing portion sandwiched between the two plates. The fixing devices may include bolts or the like, and the plates can include apertures for the bolts.

The shield may further include a device for protecting the shield against an edge of the structural member. The protection device may include a cylindrical element, such as a flexible pipe, having a split along its length such that the protection device can be fitted onto an edge of the structural member.

The sheet may include a reinforced portion, in use, the reinforced portion surrounding an aperture for allowing a component, for example a pipe/cable for services such as electricity, water or gas, to pass through the sheet. The reinforced portion may be formed of one or more extra layer of material, possibly the same as the sheet material. The aperture may be formed after the reinforced portion has been attached to the sheet.

The shield may include a flap of material (which may be the same as or different to material used for the sheet) attached to the webbing portion and/or the sheet for covering a gap between the shield and the structural member to which it is fixed. The flap may be configured to also be attached to the structural member. For example, the flap can include apertures (possibly reinforced by eyelets) through which screws or the like can be inserted to fix the flap to the structural member.

The webbing portion may be attached directly to the sheet. Alternatively, the sheet may be provided with a fixing portion, the webbing portion being attached to the fixing portion. The fixing portion may comprise one or more (typically two or three) strips of material attached to (or near to) an end edge of the sheet. The fixing portion may be formed of the same material as the webbing portions, or it may be of a different material.

Typically, one end of the webbing portion incorporates a locating device. For example, the end of the webbing portion may form a loop or it may be fitted with a hook member. The other end of the webbing portion can incorporate a locating and tensioning device, such as a ratchet tensioning device. Alternatively, both ends of the webbing portion may each include a locating and tensioning device.

The locating devices enable the shield to be attached to structural members and the tensioning device is then operated to stretch the shield to a desired degree of tautness. The webbing portions provide a strong means of attachment of the locating/tensioning devices to the sheet of material.

The locating and tensioning device may be a releasable ratchet device. The webbing portions can extend as a single strip across the whole width of the sheet, and may project from both sides thereof. The tension can then be taken up by the webbing rather than applying strain to a portion of the sheet which might cause it to tear.

The locating and tensioning device may include:

a hook portion having a mouth for engaging the structural member;

a ratchet portion including a ratchet barrel, and

a handle portion,

wherein at least a portion of the hook portion mouth is located adjacent where the webbing portion enters the locating and tensioning device.

The handle portion may have a handle grip located at an end opposite to the end of the tensioning device where the ratchet barrel is located.

The sheet material may include a coated scrim or a solid fabric. The sheet can have a base cloth of polyester, polyethylene, polypropylene, nylon or glass fibre. The base cloth may be coated with PVC, rubber, polyurethane or derivates thereof. The sheet material can be formed to from a closed or open mesh.

The webbing portions may be formed of polyester, polypropylene or nylon. The webbing may be coated with alkyd impregnation, PVC or a rubber-based compound.

According to a further aspect of the present invention there is provided a shield system including:

a first shield and a second shield, each said shield including:
a sheet of material;
a plurality of spaced apart webbing portions attached to the sheet, the webbing portions substantially extending from one end edge of the sheet to an opposite end edge;
attaching devices located at or near to both ends of the webbing portions for attaching the shield to a structural member,
the system further including:
   a first fastener device connecting a said webbing portion of the first shield a strap, and
   a second fastener device connecting the strap to a said webbing portion of the second shield.

### BRIEF DESCRIPTION OF THE DRAWINGS

The invention may be performed in various ways and embodiments thereof will now be described with reference to the accompanying drawings in which:

FIG. 1 shows an embodiment of the shield including locating and tensioning devices;

FIGS. 2A and 2B detail embodiments of the shield with reinforced portions;

FIG. 3 shows an embodiment of the shield having a flap and an aperture for services, as well as an edge protection device;

FIG. 4 shows an embodiment of the shield including a strap and a fastener device;

FIG. 5 is an exploded diagram showing the construction of the fastener device, and

FIG. 6 shows an alternative version of the locating and tensioning device that can be used with the shield.

### DETAILED DESCRIPTION OF THE DRAWINGS

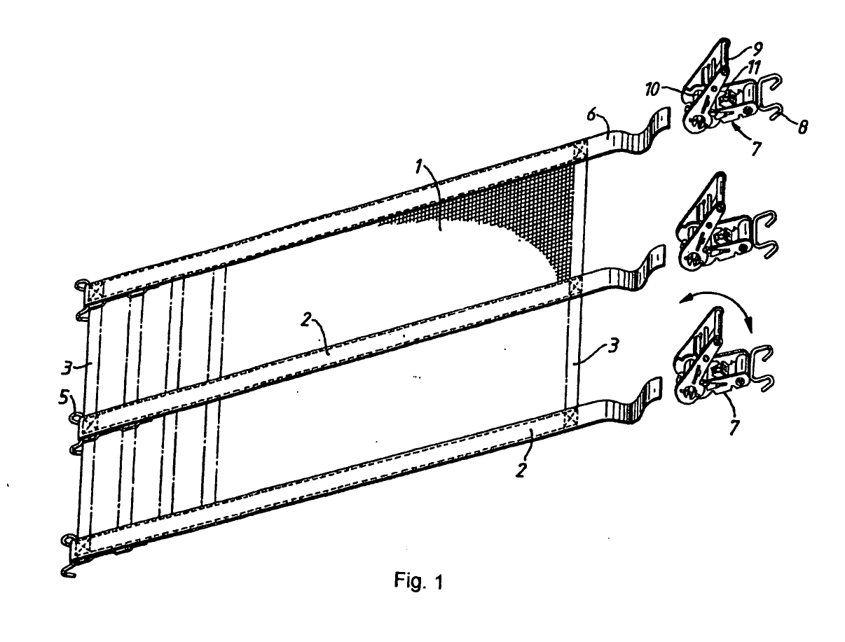

The shield illustrated in FIG. 1 comprises a sheet 1. The sheet 1 is typically made to size from a roll to suit individual applications. The sheet may be formed of coated scrims or solid fabrics of all types. The base cloth of the sheet may comprise polyester, polyethylene, polypropylene, nylon or glass fibre. A coating of PVC, rubber, polyurethane (and derivatives thereof) may be applied. In some cases more than one sheet may need to be joined together to achieve a desired width.

Strips of webbing 2 are attached all the way across sheet 1. The webbing 2 is fixed to the sheet 1 in a manner to resemble parallel lines, starting substantially from one end edge of the sheet and terminating at the opposite end edge. The distance between the individual webbing portions 2 is a function of shield design, wind load and/or application. Typically a gap of around 250 mm to 2.5 metres exists between pairs of webbing portions. The webbing portions 2 can be attached to the sheet by several methods, including high frequency, ultrasonic, hot plate or hot air welding; sewing (possibly with threads manufactured from a similar material to those used in a base cloth); heat set adhesion; two-part adhesion or air drying adhesion. For brevity, only a single webbing portion will be described below at times.

At one of its ends, the webbing portion 2 is taken back onto the sheet 1 to form a folded portion 3 at the edge of the sheet 1 and is fastened down securely to leave a loop 4 in which a hook member 5 is retained. The other end of the webbing 2 leaves an extending portion 6 for cooperating with a ratchet device 7.

The ratchet device is joined to the hook at one end 8 and a handle 9 operates a ratchet barrel 10 to cause the webbing 2 to be tensioned between hooks 5 and 8 which, in use, will have been located on a structural member to which the shield is to be attached. When the desired degree of tensioning has been achieved the sheet 1 will be held in a taut state.

The release member 11 of the device 7 can be operated to release the ratchet and thus remove the tension from the webbing strip 2. Desired portions of the sheet 1 can then be raised or lowered to provide partial access or to provide ventilation.

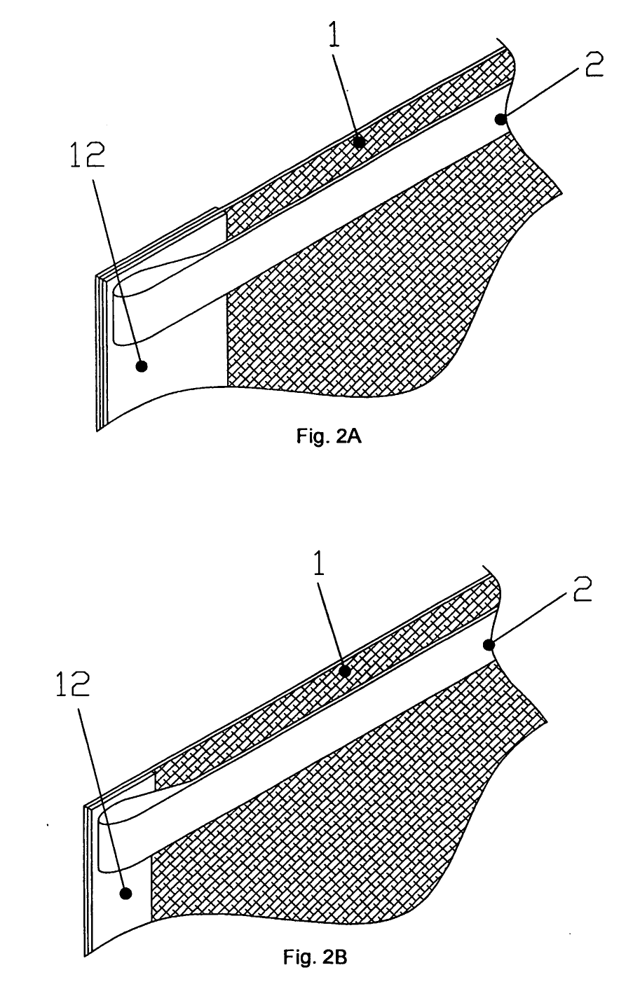

Turning to FIGS. 2A and 2B, it can be seen that the end edges of the sheet 1 can have a reinforced portion 12 to help prevent tearing. Typically the reinforced portion 12 is attached to the sheet 1 before attachment of the webbing portions 2 and the same attaching techniques mentioned above can be used. A strip of material may be fixed to one side of the sheet 1 to form a double layer as shown in FIG. 2B, or strips may be fixed to both sides of the end edge of the sheet, forming a triple layer as shown in FIG. 2A. In some situations it may not be possible to determine the end edge of the shield until it is installed. In such cases, the sheet 1 may be trimmed at the site of installation and a fastener device (as described below) can be used to attach the reinforcing layers to the sheet. In an alternative embodiment the reinforced portions 12 may be formed by folding the end edge of the sheet 1 back on itself and fixing the folded portions on top of each other, e.g. by sewing. The webbing portions 1 may be attached to the reinforced portions alone rather than directly to the sheet 1.

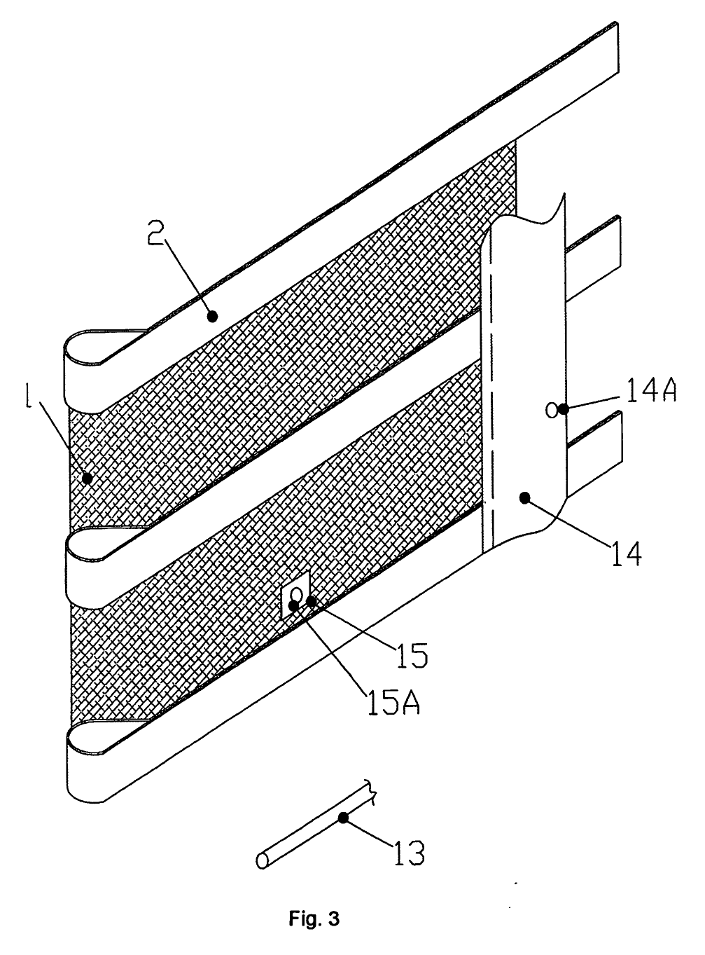

Turning to FIG. 3, it can be seen that a flap 14 of material may be added to the shield to cover any small gap between the sheet 1 and the structural member to which it is attached. The flap 14 can extend from the bottom edge of the sheet to its upper edge and can be attached to the sheet and/or webbing portions 2 by means of methods similar to those used for attaching the webbing portions 2 to the sheet 1. The flap 14 may be made from similar or dissimilar materials to the sheet or webbing portions. The flap 14 can include apertures 14A (possibly surrounded by brass or plastic eyelets) to allow the flap to be secured to the structural member by means of screws/washers; rings; quick links; snap hooks; rope; shock cord or kador section.

The sheet may be supplied with a protection device for any sharp edges on the structural member. This can also protect the sheet from abrasion damage. The protection device may be in the form of split piping 13.

If services (e.g. water pipes, electricity cables, etc) are required to pass through the shield, then the sheet 1 can be reinforced in the vicinity of the aperture through which the service element will pass by attaching one or more extra layers 15 of material to the sheet. The extra layers may be attached by any of the methods mentioned above. On installation, a shape 15A corresponding to the service component can be cut out of the reinforcing layers and the sheet so that the remaining portion of the reinforced section 15 substantially surrounds the aperture.

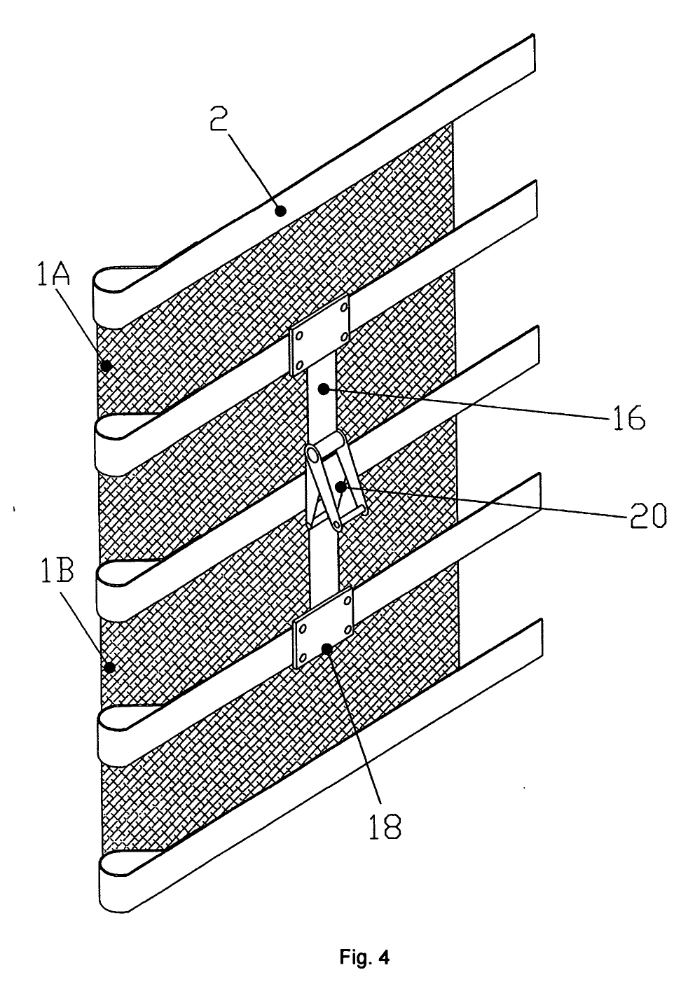

FIG. 4 shows a strap 16 being used to connect two respective webbing portions together. The two webbing portions may be attached to two separate sheets so that more than one shield can be connected together, although having the strap connecting webbing portions on a single shield can help prevent lateral deflection of the shield. Another reason why the strap may be used is when services project through a portion of the sheet. Sometimes it may be necessary to cut one of the webbing portions to accommodate the service and the strap can be used to maintain tautness in this situation. In FIG. 4, the strap 16 joins a top sheet 1A and a bottom sheet 1B. The top sheet 1A meets the bottom one 1B (and can overlap) near the third/middle webbing portion (which can be thought of as being the top webbing portion of the bottom sheet 1B).

The strap 16 is connected to the webbing portions by means of fastener devices 18. A ratchet tensioning device 20 can be attached to the strap 16 to help maintain tautness.

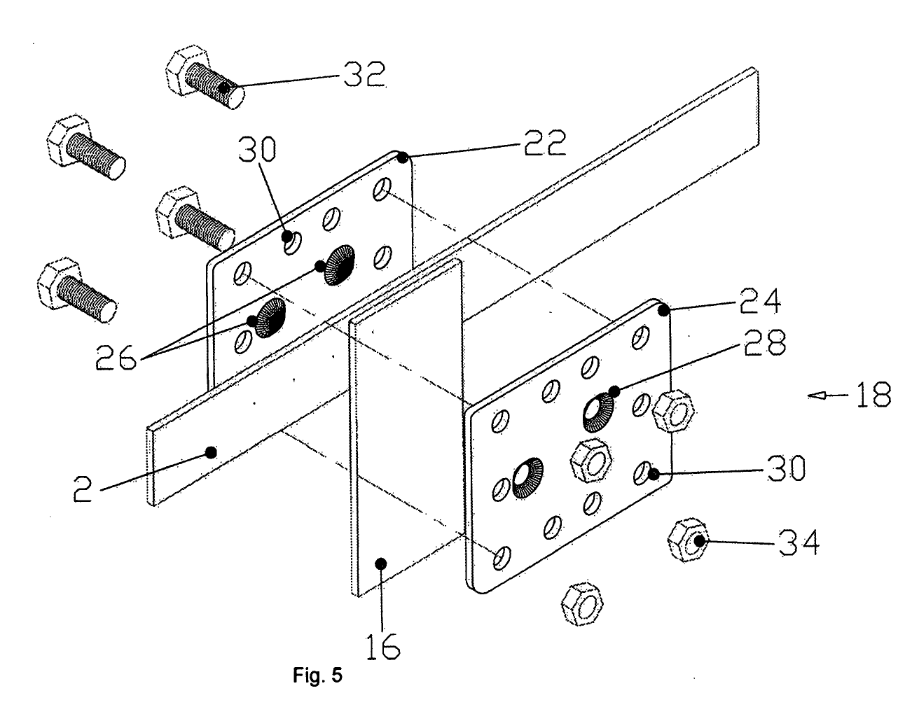

FIG. 5 details the construction of the fastener device 18. The device 18 comprises first 22 and second 24 plates, which are both generally rectangular in shape. One of the plates 22 is located on one side of the sheet 1 (not shown in FIG. 5 for clarity), the webbing portion 2 and the strap 16. The other plate is located on the opposite side so that the components 1, 2, 16 are “sandwiched” between the two plates. The first plate 22 includes two conical studs 26 located generally centrally on the plate. The second plate 24 include two apertures 28 whose positions on the plate correspond with those of the studs 26 on the first plates 22. The apertures 28 have a frusto-conical shape that can help to grip the webbing portion 2 under tension. When the plates 22 is pressed into the sheet, webbing and strap the studs 26 project through the component into the apertures 28 on the second plates 24. Thus, the components 1, 2, 16 are fixed in place relative to the two plates. The positions of the studs/apertures on the two plates can be such that all or some of the studs only project through either the webbing or the strap.

Both the plates 22,24 may contain an array of apertures 30 around their periphery through which bolts 32 can be inserted and then threaded with nuts 34, thereby improving the fastening of the two plates around the components 1, 2, 16. The apertures 30 can be located on the plates so that the bolts can be inserted through them without having to pass through the strap 16 and/or webbing portion 2.

The fasteners 18 can also be used to fix the sheet to the structural member itself in some cases.

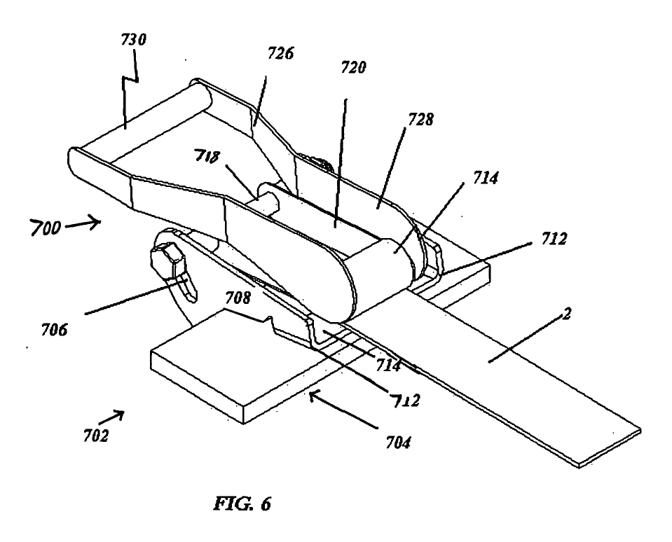

FIG. 6 shows an alternative version of the ratchet tensioning device 7 of FIG. 1. The device 700 includes a space saver hook portion 702 having a mouth 704 into which the structural member fits. From a side view the hook portion 702 comprises an elongate portion 708 with a generally crescent-shaped portion 710 depending from it. The mouth 704 is formed between the elongate portion 708 and the crescent portion 710.

As can be seen in the perspective view of FIG. 6, there are two spaced apart hook portions 702 which are joined together at the free ends of the elongate portions 708 by a perpendicular plate 714. In the parts of the two hook portions near where each elongate portion and crescent portion meet there are curved notches 716. A bolt 718 is fitted through the two notches 716. The bolt also passes through apertures in one end of a ratchet portion 720 of the device 700 that is fitted between the two hook portions. The ratchet portion 720 includes two identical parallel, spaced apart plates 722 having curved ends. The two plates 722 are joined together at the ends opposite to the bolt apertures by a ratchet barrel 724.

A handle portion 726 is pivotably mounted on the ends of the ratchet barrel 724. The handle portion comprises two elongate flat bars 728 that have first portions running substantially parallel to each other. The bars 728 have angled middle portions starting near where they meet the bolts in FIG. 6. The bars 728 diverge and widen and lead to a third portion where the two bars run substantially parallel to each other again. The widened ends of the bars are joined together by a handle grip 730. It will be appreciated by the person skilled in the art that certain parts suitable for use in the device 700 are commercially available.

In use, an end of the webbing portion 2 is inserted between the ratchet barrel 724 and the plate 714 of the hook portion 702. The handle 730 is used to tension/loosen the webbing portion as desired. Thus, in the device 700 the mouth 704 of the hook portion is located generally adjacent where the webbing portion enters the device. This results in the device 700 being more compact than the ratchet tension device 7 of FIG. 1 where the hooks on the ratchet device 7 project beyond the end of the device, leading to a greater gap between the shield and the structural member.

1. A shield including:
a sheet (1) of material;
a plurality of spaced apart webbing portions (2) attached to the sheet, the webbing portions substantially extending from one end edge of the sheet to an opposite end edge;
attaching devices (5, 7) located at or near to both ends of the webbing portions for attaching the shield to a structural member,
and a fastener device (18) connecting a said webbing portion to a strap (16), the strap in use also being connected to a webbing portion of another shield or to the structural member.

2. A shield according to claim 1, further including a device (20) for tensioning the strap (16).

3. A shield according to claim 1, wherein the fastener device (18) includes a pair of plates (22, 24), in use, one said plate being located on one side of the shield and the other plate being located on the opposite side of the shield.

4. A shield according to claim 3, wherein one of the plates (22) includes one or more stud (26) such that, in use, the or each stud presses into the strap (16) and/or a said webbing portion (2), thereby substantially fixing the strap and/or the webbing portion between the plates (22, 24).

5. A shield according to claim 4, wherein the other plate (24) includes one or more aperture (28) corresponding to the one or more stud (26).

6. A shield according to claim 3, wherein the fastener device (18) further includes a plurality of fixing devices (32, 34) for fixing the two plates (22, 24) together with the strap (16) and the webbing portion (2) being sandwiched between the two plates.

7. A shield according to claim 1, further including a device (13) for protecting an edge of the sheet (1).

8. A shield according to claim 1, wherein the sheet (1) includes a reinforced portion (15), in use, the reinforced portion surrounding an aperture (15A) for allowing a component to pass through the sheet.

9. A shield according to claim 8, wherein the reinforced portion (15) is formed of one or more extra layer of the sheet (1) material.

10. A shield according to claim 1, including a flap (14) of material attached to a said webbing portion (2) and/or the sheet (1) for covering a gap between the shield and the structural member to which it is attached.

11. A shield according to claim 10, wherein the flap (14) is also attached to the structural member.

12. A shield according to claim 1, wherein the sheet (1) is provided with a fixing portion (12), the webbing portion (2) being attached to the fixing portion.

13. A shield according to claim 12, wherein the fixing portion (12) comprises one or more strips of material attached to or near to an end edge of the sheet (1).

14. A shield according to claim 1, wherein one end of the webbing portion (2) incorporates a locating device (5) and the other end of the webbing portion incorporates a locating and tensioning device (7, 700).

15. A shield according to claim 1, wherein both ends of the webbing portion (2) each include a locating and tensioning device (7, 700).

16. A shield according to claim 1, wherein the locating and tensioning device comprises a releasable ratchet device (7, 700).

17. A shield according to claim 1, wherein the locating and tensioning device (700) includes:
a hook portion (702) having a mouth (704) for engaging the structural member;
a ratchet portion (720) including a ratchet barrel (724), and a handle portion (726), wherein at least a portion of the hook portion mouth is located adjacent where the webbing portion (2) enters the locating and tensioning device.

18. A shield according to claim 17, wherein the handle portion (726) includes a handle grip (730) located at an end opposite to the end of the tensioning device (700) where the ratchet barrel (724) is located.

19. A shield according to claim 1, wherein the sheet (1) material includes a coated scrim or a solid fabric.

20. A shield according to claim 19, wherein the sheet (1) has a base cloth of polyester, polyethylene, polypropylene, nylon or glass fibre.

21. A shield according to claim 20, wherein the base cloth is coated with PVC, rubber, polyurethane or derivatives thereof.

22. A shield according to claim 1, wherein the webbing portions (2) are formed of polyester, polypropylene or nylon.

23. A shield according to claim 22, wherein the webbing portions (2) are coated with alkyd impregnation, PVC or a rubber-based compound.

24. A shield system including:
a first shield (1A) and a second shield (1B), each said shield including:
a sheet of material (1);
a plurality of spaced apart webbing portions (2) attached to the sheet, the webbing portions substantially extending from one end edge of the sheet to an opposite end edge;
attaching devices (5, 7) located at or near to both ends of the webbing portions for attaching the shield to a structural member, the system further including:
a first fastener device (18) connecting a said webbing portion of the first shield (1A) to a strap (16), and a second fastener device (18) connecting the strap to a said webbing portion of the second shield (18).

25. A shield including:
a sheet (1) of material;
a plurality of spaced apart webbing portions (2) attached to the sheet, the webbing portions substantially extending from one end edge of the sheet to an opposite end edge;
and a reinforced portion (15) that surrounds an aperture (15A) in the sheet for allowing a component to pass through the sheet.
